(19) United States
(12) Patent Application Publication
(10) Pub. No.: US 2013/0166259 A1
(43) Pub. Date: Jun. 27, 2013

(54) SYSTEM LINEARIZATION

(71) Applicant: Analog Devices, Inc., Norwood, MA (US)

(72) Inventors: Theophane Weber, Cambridge, MA (US); Benjamin Vigoda, Winchester, MA (US); Patrick Pratt, Co. Cork (IE); Joshua Park, Billerica, MA (US); Martin McCormick, Boston, MA (US)

(73) Assignee: Analog Devices, Inc., Norwood, MA (US)

(21) Appl. No.: 13/678,904

(22) Filed: Nov. 16, 2012

Related U.S. Application Data
(60) Provisional application No. 61/560,889, filed on Nov. 17, 2011.
(60) Provisional application No. 61/703,895, filed on Sep. 21, 2012.

(51) Int. Cl. G06F 17/50

(52) U.S. Cl. CPC G06F 17/5009
USPC 703/2

(57) ABSTRACT

A method for linearizing a non-linear system element includes acquiring data representing inputs and corresponding outputs of the non-linear system element. A model parameter estimation procedure is applied to the acquired data to determine model parameters of a model characterizing input-output characteristics of the non-linear element. An input signal representing a desired output signal of the non-linear element is accepted and processed to form a modified input signal according to the determined model parameters. The processing includes, for each of a series of successive samples of the input signal, applying an iterative procedure to determining a sample of the modified input signal according to a predicted output of the model of the non-linear element. The modified input signal is provided for application to the input of the non-linear element.

### CROSS-REFERENCE TO RELATED APPLICATIONS

This application claims the benefit of U.S. Provisional Application No. 61/560,889 filed Nov. 17, 2011, and to U.S. Provisional Application No. 61/703,895 filed Sep. 21, 2012. These applications are incorporated herein by reference.

### BACKGROUND

This invention relates to linearization of a system that includes a non-linear element, in particular to linearization of a electronic circuit having a power amplifier that exhibits non-linear input/output characteristics.

Many systems include components which are inherently non-linear. Such components include but are not limited to motors, power amplifiers, diodes, transistors, vacuum tubes, etc.

In general, a power amplifier has an associated operating range over a portion of which the power amplifier operates substantially linearly and over a different portion of which the power amplifier operates non-linearly. In some examples, systems including power amplifiers can be operated such that the power amplifier always operates within the linear portion of its operation range. However, certain applications of power amplifiers, such as in cellular base stations may use power amplifiers to transmit data according to transmission formats such as wideband code division multiple access (WCDMA) and orthogonal frequency division multiplexing (OFDM). Use of these transmission formats may result in signals with a high dynamic range. For such applications, transmitting data only in the linear range of the power amplifier can be inefficient. Thus, it is desirable to linearize the non-linear portion of the power amplifier's operating range such that data can safely be transmitted in that range.

One effect of non-linear characteristics in a radio frequency transmitter is that the non-linearity results in increase in energy outside the desired transmission frequency band, which can cause interference in adjacent bands.

### SUMMARY

In one aspect, in general, a method for linearizing a non-linear system element includes acquiring data representing inputs and corresponding outputs of the non-linear system element. A model parameter estimation procedure is applied to the acquired data to determine model parameters of a model characterizing input-output characteristics of the non-linear element. An input signal representing a desired output signal of the non-linear element is accepted and processed to form a modified input signal according to the determined model parameters. The processing includes, for each of a series of successive samples of the input signal applying an iterative procedure to determining a sample of the modified input signal according to a predicted output of the model of the non-linear element. The modified input signal is provided for application to the input of the non-linear element.

Aspects can include one or more of the following features.

The non-linear system element comprises a power amplifier, for example, a radio frequency power or an audio frequency power amplifier.

Applying the model parameter estimation procedure comprises applying a sparse regression approach, including selecting a subset of available model parameters for characterizing input-output characteristics of the model.

Applying the iterative procedure comprises applying a numerical procedure to solve a polynomial equation or applying a belief propagation procedure.

Applying the iterative procedure to determining a sample of the modified input signal according to a predicted output of the model of the non-linear element comprises first determining a magnitude of the sample and then a phase of said sample.

The model characterizing input-output characteristics of the non-linear element comprises a memory polynomial.

The model characterizing input-output characteristics of the non-linear element comprises a Volterra series model.

The model characterizing input-output characteristics of the non-linear element comprises a model that predicts an output of the non-linear element based data representing a set of past inputs and a set of past outputs of the element. In some examples, the model characterizing input-output characteristics of the non-linear element comprises an Infinite Impulse Response (IIR) model.

Acquiring data representing inputs and corresponding outputs of the non-linear system element comprises acquiring non-consecutive outputs of the non-linear element, and the model parameter estimation procedure does not require consecutive samples of the output.

In another aspect, in general, software stored on a machine-readable medium comprises instructions to perform all the steps of any of the processes described above.

In another aspect, in general, a system is configured to perform all the steps of any of the processes described above.

Aspects can include the following advantages.

By estimating parameters of a model of the non-linear system element (i.e., a forward model from input to output) rather than parameters that directly represent a predistorter (e.g., an inverse model), a more accurate linearization may be achieved for a given complexity of model.

Performing the iterative procedure for each sample provides accurate linearization and in many implementations, requires relatively few iterations per sample.

Other features and advantages of the invention are apparent from the following description, and from the claims.

### DESCRIPTION OF DRAWINGS

FIG. 1 is a first power amplifier linearization system.

FIG. 2 is a second power amplifier linearization system.

FIG. 3 is a factor graph for determining a pre-distorted input to a power amplifier.

### DESCRIPTION

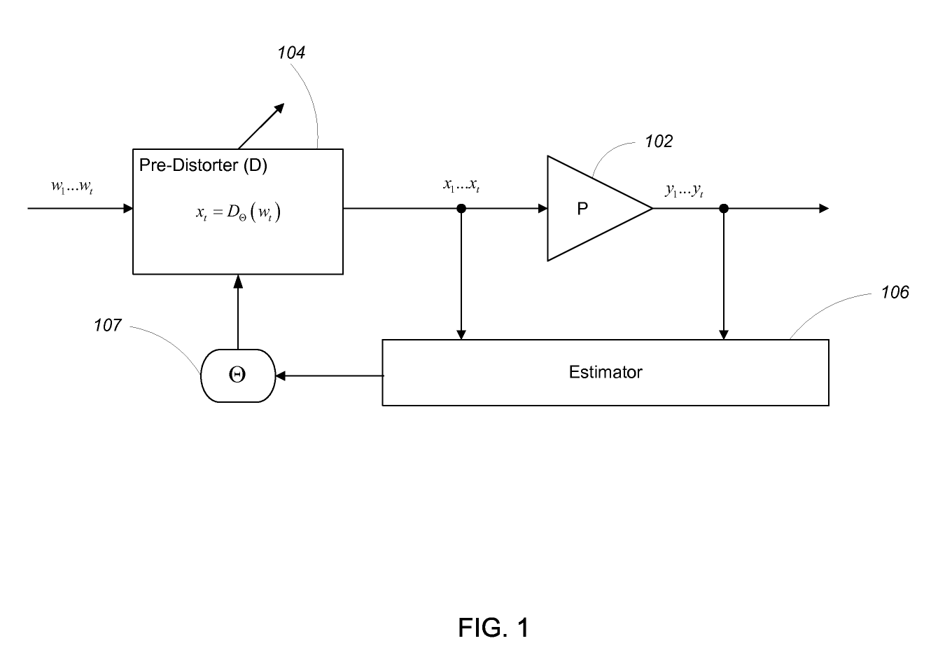

Referring to FIG. 1, one or more approaches described below are directed to a problem of compensating for non-linearities in a system component. The approaches are described initially in the context to linearizing a power amplifier, but it should be understood that this is only one of a number of possible contexts for the approach.

In FIG. 1, a non-linear element P 102, for example, a power amplifier, accepts a discrete time series time series x₁, . . . , xₜ and outputs a time series y₁, . . . , yₜ=P(x₁, . . . , xₜ). If P 102 were ideal and linear, and assuming it has unit gain, then yᵢ=xᵢ for all i. The element 102 is not ideal, for example, because the element 102 introduces a memoryless nonlinearity, and more generally, because the non-linearity of the element has memory, for example, representing electrical state of the element.

It should be understood that in the discussion below, the input and outputs of the non-linear element are described as discrete time signals. However, these discrete time values are equivalently samples of a continuous (analog) waveform, for example, sampled at or above the Nyquist sampling rate for the bandwidth of the signal. Also, case of a radio frequency amplifier, in some examples, the input and output values are baseband signals, and the non-linear element includes the modulation to a transmission radio frequency and demodulation back to the baseband frequency. In some examples, the inputs represent an intermediate frequency signal that represents a frequency multiplexing of multiple channels. Furthermore, in general, the inputs and output are complex values, representing modulation of the quadrature components of the modulation signal.

Referring to FIG. 1, one approach to compensating for the non-linearity is to cascade a predistortion element (predistorter) D 104, often referred to as a Digital Pre-Distorter (DPD), prior to the non-linear element 102 such that a desired output sequence w₁, . . . , wₜ is passed through D 104 to produce x₁, . . . , xₜ such that the resulting output y₁, . . . , yₜ matches the desired output to the greatest extent possible. In some examples, as illustrated in FIG. 1, the predistorter is memoryless such that the output xₜ of the predistorter is a function of the desired output value wₜ, such that xₜ=D_{Θ}(wₜ) for some parameterized predistortion function D_{Θ}( ).

As introduced above, in some examples, the predistortion function is parameterized by a set of parameters Θ 107. These parameters can be tracked (e.g., using a recursive approach) or optimized (e.g., in a batch parameter estimation), for example by using an estimator 106, to best match the characteristics of the actual non-linear element P 102 to serve as a pre-inverse of its characteristics. In some examples, the non-linear element P has a generally sigmoidal input-output characteristic such that at high input amplitudes, the output is compressed. In some examples, the parameters Θ characterize the shape of the inverse of that sigmoidal function such that the cascade of D 104 and P 102 provides as close to an identity (or linear) transformation of the desired output wₜ.

Note that in general, a predistorter of the type shown in FIG. 1 is not necessarily assumed to be memoryless. For example, xₜ can, in addition to wₜ depend on a window of length T of past inputs x_{t-T}, . . . , xₜ₋₁ to the non-linear element, and if available, may also depend on measured outputs y_{t-T}, . . . , yₜ₋₁ of the nonlinear element itself. The functional forms of D 104 that have been used including memory polynomials, Volterra series, etc., and various approaches to estimating the parameters Θ 107, for example, using batch and/or adaptive approaches have been used.

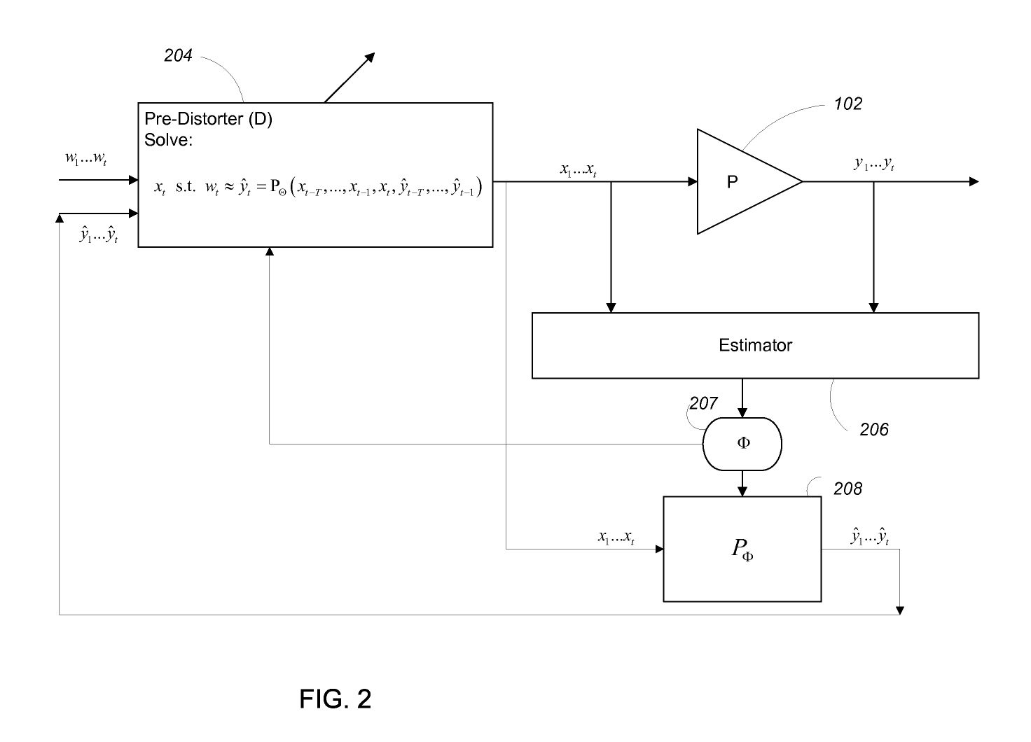

Referring to FIG. 2, an alternative approach makes use of a different architecture than that shown in FIG. 1. In the architecture shown in FIG. 2, a predistorter D 204 is used in tandem with the nonlinear element 102. Operation of the predistorter is controlled by a set of estimated parameters Θ. However, rather than parameterizing the predistorter D directly with a set of parameters Θ to serve as a suitable pre-inverse as in FIG. 1, operation of the predistorter is controlled by a set of parameters Φ that characterize the non-linear element P 102 itself. In particular, a model P_{Φ} 208 is parameterized by Φ to best match the characteristics of the true non-linear element P 102.

As is more fully discussed below, the parameters Φ may be determined from a past paired samples (x₁, y₁), . . . , (x_{τ}, y_{τ}) observed that the inputs and outputs of the true non-linear element. As with possible direct parameterizations of a predistorter, a variety of parameterizations of P_{Φ} 208 may be used, as is discussed further later in this description.

In general, the model P_{Φ} 208 provides a predicted output ŷₜ from a finite history of past inputs up to the current time x_{t-T}, . . . , xₜ as well as a finite history up to the previous time of predicted outputs ŷ_{t-T}, . . . , ŷₜ₋₁. Very generally, operation of the predistorter D 204 involves, for each new desired output wₜ, finding the best xₜ such that wₜ=P_{Φ}(x_{t-T}, . . . , xₜ, ŷ_{t-T}, . . . , ŷₜ₋₁) exactly, or that minimizes a distortion ∥wₜ−P_{Φ}(x_{t-T}, . . . , xₜ, ŷ_{t-T}, . . . , ŷₜ₋₁)∥.

Operation of the architecture shown in FIG. 2 depends on characteristics of the system including:
a. The functional form of the model P_{Φ} 208;
b. The procedure used by the predistorter to determine successive values of xₜ such that the model outputs ŷₜ match the desired outputs wₜ; and
c. The procedure used to estimate the model parameters Φ using the estimator 206.

Turning first to the functional form of the nonlinearity model, choices include Volterra series, memory polynomials (optionally generalized with cross terms), and kernel function based approaches.

One specific example of a parametric form of P_{Φ} 208, we assume an N^{th} order memory polynomial of the form

$${\hat{y}}_{t} = {P}_{Φ} ( {x}_{t - T} , … , {x}_{t} ) = {\sum }_{j = 0}^{T} {\sum }_{k = 0}^{N} {a}_{j , k} {\vert {x}_{t - j} \vert}^{k} {x}_{t - j}$$

such that the parameters are Φ=(a_{j,k};0≦j≦T,0≦k≦N).

In some examples, other forms of the model P_{Φ} may also be used. For example, a memory polynomial including cross terms may be used:

$${\hat{y}}_{t} = {\sum }_{i = 0}^{T} {\sum }_{j = 0}^{T} {\sum }_{k = 0}^{N} {a}_{i , j , k} {\vert {x}_{t - j} \vert}^{k} {x}_{t - i} .$$

Yet other forms can be used, including an internal feedback (“infinite impulse response”, “IIR”) form, such as

$${\hat{y}}_{t} = {x}_{t} - {\sum }_{i = 1}^{T} {\sum }_{j = 1}^{T} {\sum }_{k = 0}^{N} {a}_{i , j , k} {\vert {\hat{y}}_{t - j} \vert}^{k} {\hat{y}}_{t - i} .$$

Yet other forms make use of physically motivated models in which hidden state variables (e.g., temperature, charge, etc.) are included and explicitly accounted for in a factor graph.

Turning now to implementation of the predistorter, in some examples, each time output involves solution of a polynomial equation. In some examples, the parameterization of P_{Φ} 208 is decomposable into a term that depends on xₜ, and a term that only depends on past values x_{t-τ} and/or past values ŷ_{t-τ}:

wₜ=F_{Φ}(xₜ, . . . )+G_{Φ}(x_{t-T}, . . . , xₜ₋₁, ŷ_{t-T}, . . . , ŷₜ₋₁).

At a particular time step t, the term G_{Φ} is treated as a constant g, which depends both on the parameters Φ, and in general on past values x_{t-τ} and/or past values ŷ_{t-τ} and the term F_{Φ} is a function ƒ(xₜ) of the one unknown complex variable xₜ, where the particular function ƒ depends both on the parameters Φ, and in general (e.g., in a memory polynomial with cross terms) on past values x_{t-τ} and/or past values ŷ_{t-τ} (e.g., in an IIR memory polynomial form). Therefore, the goal at that time step is to find a xₜ such that ƒ(xₜ)=wₜ+g.

Taking an example of a memory polynomial, ƒ(x) has the function form ƒ(x)=b₀x+Σ_{k≧1}bₖ|x|^{k} x. Note that x is complex, so that ƒ(x) is not strictly a polynomial function and therefore convention methods for finding roots of a polynomial are not directly applicable to find xₜ. One approach to solving ƒ(x)=z is to apply Picard's method, which comprises an iteration beginning at an initial estimate x⁽⁰⁾, for example x⁽⁰⁾=z and iterating over k:

$${x}^{( k + 1 )} = \frac{1}{{b}_{0}} ( y - ( f ( {x}^{( k )} ) - {b}_{0} {x}^{( k )} ) ) .$$

In this approach, assuming that the parameters Φ are known, predistortion approach is as follows:

For t=0,1, . . . .
Determine parameters bₖ for ƒ( ) and fixed term g based on parameters Φ, and (in general) on past values x_{t-τ} and/or past values ŷ_{t-τ};
Initialize x⁽⁰⁾=wₜ−g;
For k=1,2, . . . , K

$${x}^{( k + 1 )} = \frac{1}{{b}_{0}} ( y - ( f ( {x}^{( k )} ) - {b}_{0} {x}^{( k )} ) ) ;$$

Set xₜ=x^{(K)};
Predict ŷₜ based on Φ and new xₜ;

Other approaches than Picard's method may be used to solve for the best xₜ that matches the model output ŷₜ with the desired output wₜ can be used. For example, a two-dimensional Newton Raphson approach may be used in which the argument of ƒ is treated as a two dimensional vector of the real and imaginary parts of x, and the value of ƒ is similarly treated as a two-dimensional vector. Yet another approach is to represent the argument and value of ƒ in polar form (i.e., as a magnitude and a complex angle), and solve for the magnitude using a one-dimensional Newton Ralphon approach, and then solving for the angle after the magnitude is known.

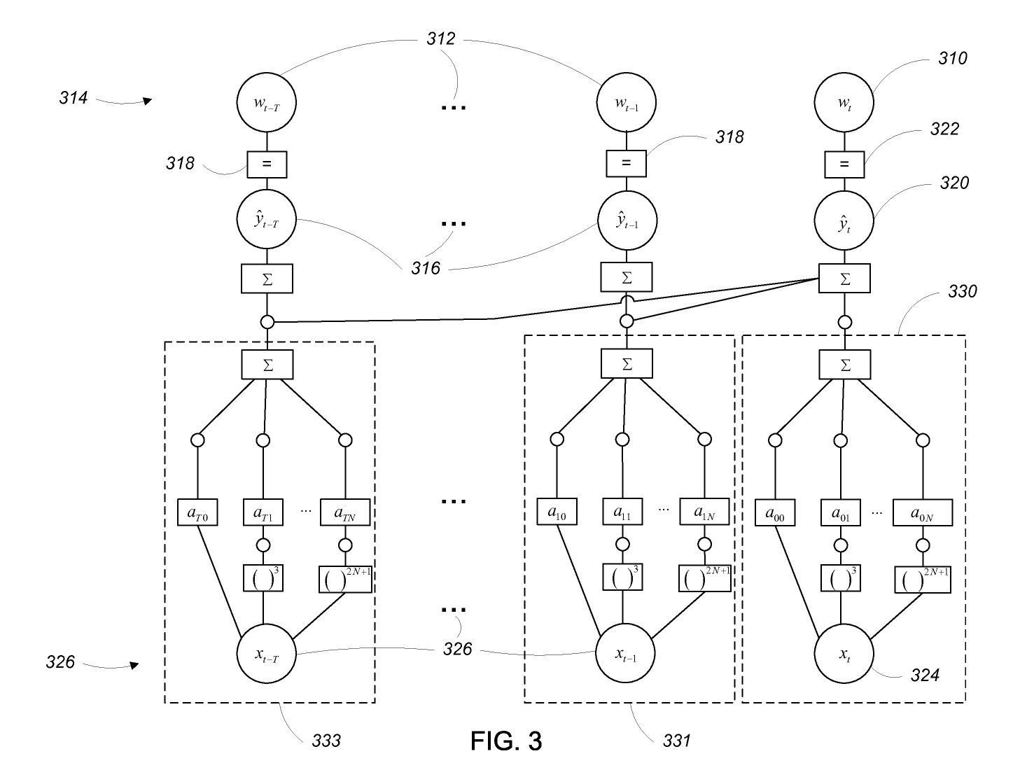

Referring to FIG. 3, another approach to determining xₜ at each time step is to use a factor graph 300, which is illustrated for the case of a memory polynomial without cross terms. In this case, the model takes the form

wₜ=F_{Φ}(xₜ)+G_{Φ}(x_{t-T}, . . . , xₜ₋₁, ŷ_{t-T}, . . . , ŷₜ₋₁)

where F_{Φ} does not depend on past values x_{t-τ} or y_{t-τ}, taking the form

$${F}_{Φ} ( {x}_{t} ) = {\sum }_{k = 0}^{N} {a}_{0 , k} {\vert {x}_{t} \vert}^{k} {x}_{t} .$$

One interpretation of the function of the factor graph is to implicitly compute the inverse

xₜ=F_{Φ}⁻¹(wₜ−G_{Φ}(x_{t-T}, . . . , xₜ₋₁, ŷ_{t-T}, . . . , ŷₜ₋₁).

Referring to FIG. 3, the factor graph 300 representing the N^{th} order memory polynomial described above can be implemented by the predistorter 204 of FIG. 2. In the factor graph 300, the current desired output value, wₜ 310 and a number of past desired output values, wₜ₋₁ . . . w_{t-T} 312 are known and illustrated in a top row 314 of variable nodes. Each variable node associated with a past desired output value, wₜ₋₁ . . . w_{t-T} 312 is coupled to a corresponding past estimated output variable, yₜ₋₁ . . . y_{t-T} 316 through an equal node 318. The current desired output variable, wₜ 310 is coupled to the predicted output ŷₜ 320 through an equal node 322.

A pre-distorted input value, xₜ 324 and a number of past pre-distorted input values, xₜ₋₁ . . . x_{t-T} 326 are illustrated in the bottom row 328 of variable nodes. The past pre-distorted input values 326 are known and the current pre-distorted input value 324 is the value that is computed and output as the result of the factor graph 300.

In the current example, the factor graph 300 can be seen as including a number of sections 330, 331, . . . , 333, each related to the desired inputs and predicted outputs at a given time step. In this example, each section 330, 331, . . . , 333 includes a number of function nodes and variable nodes for calculating

a_{j,k}|xₜ₋ⱼ|^{k} xₜ₋ⱼ

for a single value of j and all values of k=0 . . . N (where N=2 in the current example).

For example, the first section 330 calculates the value of the memory polynomial for j=0 and k=0 . . . N as:

$${\sum }_{k = 0}^{N} {a}_{0 , k} {\vert {x}_{t} \vert}^{k} {x}_{t} ,$$

the second section 331 calculates the value of the memory polynomial for j=1 and k=0 . . . N as:

$${\sum }_{k = 0}^{N} {a}_{1 , k} {\vert {x}_{t - 1} \vert}^{k} {x}_{t - 1} ,$$

and so on.

The sections 330, 331, . . . , 333 are interconnected such that the result of each section is summed, resulting in a factor graph implementation of the memory polynomial:

$${\hat{y}}_{t} = {\sum }_{j = 0}^{T} {\sum }_{k = 0}^{N} {a}_{j , k} {\vert {x}_{t - j} \vert}^{k} {x}_{t - j}$$

Note one of the portions (i.e., portion 330) of the factor graph 300 effectively represents F_{Φ} identified above. In particular, the portion 330 of the factor graph 300 implements

$${F}_{Φ} ( {x}_{t} ) = {\sum }_{k = 0}^{T} {a}_{0 , k} {\vert {x}_{t} \vert}^{k} {x}_{t}$$

This section 330 has a functional from which remains fixed as long as the parameters, Φ, remain fixed. In some examples, this fixed section 330 of the factor graph 300 is replaced with a lookup table which is updated each time the parameters are updated.

The remaining sections (331, . . . , 333) of the factor graph 300 implement

$${G}_{Φ} ( ) = {\sum }_{j = 1}^{T} {\sum }_{k = 0}^{N} {a}_{j , k} {\vert {x}_{t - j} \vert}^{k} {x}_{t - j}$$

In operation, to calculate the output value, xₜ 324, messages are passed between nodes in the graph, where each message represents a summary of the information known by that node through its connections to other nodes. Eventually, the factor graph converges to a value of xₜ. The resulting value of xₜ is a pre-distorted value which, when passed to the non-linear element (e.g., FIG. 2, element 204), causes the non-linear element to output a value ŷₜ which closely matches the desired value wₜ.

Note that the factor graph shown in FIG. 3 is one example, which is relatively simple. Other forms of factor graph may include different model structures. Furthermore, parameters of the model, shown in FIG. 3 as parameters (e.g., a_{i,j}) of function nodes may themselves be variables in a graph, for example, in a Bayesian framework. For example, such parameters variable may link a portion of a factor graph that constrains (estimates) the parameters based on past observations of (xₜ, yₜ) pairs.

Turning now to aspects related to estimation of parameters Φ, we note that although the predistorter functions at the time scale of the signal variations that are passed through the non-linear element, estimation may be performed at a slower timescale, for example, updating the parameters relatively infrequently and/or with a time delay that is substantial compared to the sample time for the signal.

In some examples, the power amplifier linearization systems described above include two subsystems. The first subsystem implements a slower adaptation algorithm which takes blocks of driving values, xₜ, . . . , x_{t+τ} and yₜ, . . . , y_{t+τ} as inputs and uses them to estimate an updated set of parameters, Φ. The updated set of parameters are used to configure a predistorter (e.g., FIG. 2, element 204) which operates in a faster transmit subsystem. One reason for using such a configuration is that estimating the updated parameters can be a computationally intensive and time consuming task which can not feasibly be accomplished in the transmit path. Updating the parameters at a slower rate allows for the transmit path to operate at a high rate while still having an updated set of parameters for the predistorter.

Various approaches to estimating Φ may be used. In some examples, sparse sampling and/or cross validation techniques may be used. In some examples, the number of number of non-zero parameter values can be limited such that overfitting of the memory polynomial does not occur. In some examples, the parameters are adapted using algorithms such as LMS or RLS.

It is noteworthy that although the input-output characteristic of the model is non-linear, the dependency of the model on its parameters may be linear. For example, in the case of a memory polynomial, the output can be represented as

yₜ=Φ^{T}φ(t),

where

$$φ ( t ) = {[ {\sum }_{k = 0}^{N} {\vert {x}_{t - j} \vert}^{k} {x}_{t - i} \text{:} i = 0 , … , I ; j = 0 , … , J ; k = 0 , … , K ]}^{T}$$

and I is the number of taps, J is the number of cross terms, and K is the polynomial order. One approach is to use a set of (yₜ, φ(t)) pairs to determine a minimum mean squared estimate Φ by choosing Φ=(φ^{T}φ)⁻¹φ^{T} y where φ is the matrix formed by φ(t).

In some examples, the estimate is performed periodically in a batch process, for example, collecting data for a time interval, computing Φ, and then operating the predistorter with those parameters. While operating with one set (vector) of parameters, in parallel new data may be collected for computing updated parameters.

Several aspects of the parameter estimation process are significant, including:
a. Avoiding overfitting the model
b. Avoiding extrapolation errors
c. Time sampling approaches for collecting the data from which the model parameters are obtained

One approach to avoid over-fitting is to assign a regularization prior on the coefficients theta. A regularizing prior could for instance be a Gaussian prior with standard deviation σ, which corresponds in the regression over Φ to an additional L2 cost (ΣΦᵢ²) with multiplicative coefficient 1/σ². For instance, this means that, in a linear regression, instead of minimizing

$${\sum }_{t} {\vert actual\_output ( t ) - predicted\_output ( t , θ ) \vert}^{2} ,$$

we minimize

$${\sum }_{t} {\vert actual\_output ( t ) - predicted\_output ( t , θ ) \vert}^{2} + ( 1 / {σ}^{2} ) {\sum }_{i} {\vert {φ}_{i} \vert}^{2} ) .$$

In order to determine the optimal σ, one can compute the regression for a family of σ's, and use cross-validation to determine which sigma corresponded to the best generalization error (error computed on data not used in the training set).

It should be evident that there are potentially a great many parameters in the parameter set (vector) Φ. One approach to avoiding over-fitting makes use of sparse regression approaches. Generally, in such sparse regression approaches, only a limited number of elements of Φ are permitted to be non-zero. Examples of sparse regression approaches that are well known include matching pursuit, orthogonal matching pursuit, lasso, and cosamp. A benefit of sparse regression is also that the resulting predistortion has lower power and a reduced adaptation time. Another technique for sparse regression is to assign an additional sparsifying prior (such as an L₁ prior,

$${\sum }_{i} \vert {φ}_{i} \vert )$$

to the parameter set Φ. This prior can be combined with a regularizing prior as discussed above.

The inversion necessary for the calculation of Θ may be poorly conditioned. While regularization may help, a more effective solution is to use a linear combination of orthogonal polynomials instead of a linear combination of monomials. Here

$${\sum }_{k = 0}^{N} {a}_{j , k} {\vert {x}_{t - j} \vert}^{k}$$

is replaced with a linear combination of orthogonal polynomials (e.g., Laguerre polynomials, Hermite polynomials, Chebyshev polynomials, etc . . . ). This improves the conditioning of a minimum mean squared solution for RLS, and improves the convergence rate of algorithms such as LMS.

Another approach to regression makes use of frequency weighting, whose aim is to increase the quality of the model. In this approach, filter each component of the feature vector φₜ, and filter the output vector yₜ, and do the regression on those filtered components instead. The effect of doing so is that if the filter is weighted towards particular frequency bands, the model quality will increase on those corresponding bands. Note that this is not the same as traditional data filtering—we are not filtering data so that it has a particular frequency response; we are filtering the data that goes into the regression model so that the model decreases its error in particular frequency bands, for example, in sidelobe frequency bands.

In order to comply with wireless regulations, it is often necessary to reduce nonlinear distortion products in specific frequency bands (e.g., in adjacent channels) more than others. This can be accomplished by training the model to emphasize accuracy in these “critical bands”. To incorporate frequency emphasis, a linear filter is designed (FIR or IIR) with a frequency response that amplifies the critical bands and attenuates the non-critical bands. The feature vectors in φₜ are passed through this filter to give a new weighted feature vector φ′ₜ. The output yₜ is also passed through the same filter to give a weighted output \y′ₜ. Regression proceeds on φ′ₜ and y′ₜ instead of φₜ and yₜ. The minimum mean squared solution is calculated Φ=(φ′^{T}φ′)⁻1φ′^{T} y′. This now minimizes the overall model prediction error but where error in the critical bands is weighted proportional to the amplification specified in the emphasis filter. It is understood that this weighting method applies to RLS and LMS as well.

In some cases, it may be difficult to compute y′ₜ (e.g., if the output vector \yₜ was sampled sparsely). To mitigate this, the calculation for Φ can be modified to include the filtering of y in φ′ instead: Φ=(φ′^{T}φ′)⁻1φ″^{T} y. Where φ″(t) is the result of filtering φ(t) twice (i.e., filtering φ′(t) again). This corresponds exactly to the original weighted minimum mean squared solution but does not require filtering yₜ.

Another issue that can arise due to repeated estimation of Φ is that even if the model does not overfit the data for the sampling window used for the estimation, the sampling window may not provide a sufficient richness of data over a range input conditions such that it the input characteristics change, the model may in fact extrapolate poorly, and potentially match worse than a simple linear model. An example of such a scenario can occur when the training data represents a relatively low power level, and the estimated model parameters match that low power operating condition well. However, if the power level increases, for example, to a degree that provokes non-linear characteristics, the model may essentially be extrapolating poorly.

One approach is to synthesize a training set for parameter estimation by merging data from a high-power situation, which may have been recorded in relatively old time interval, with actual samples in a relatively recent time interval. This combination yields good linearization in the operating condition in the recent time interval, as well as good linearization in an operating condition represented by the older high-power time interval. Furthermore, power levels in between are essentially interpolated, thereby improving over the extrapolation had the high-power data not been included.

Note that other approaches to synthesis of the training data sets may be used. For example, multiple older training intervals may be used to sample a range of operating conditions. In some examples, stored training data may be selected according to matches of operating conditions, such as temperature. Also, stored training data may be segregated by frequency (e.g., channel) in order to provide diversity in the training data across different frequencies even when the most recent training interval may represent data that is concentrated or limited to particular frequencies.

A third aspect relates to estimation of the model parameters. Recall that the estimation can be expressed as being based on a set of data pairs (yₜ, φ(t)) where φ(t) includes all the non-linear terms (i.e., including all the cross-terms) that are used in the model. A goal is to provide a mapping that is valid for all t from φ(t) to yₜ. However, it is not necessary to sample these data pairs at consecutive time samples, and more importantly one can sample yₜ in a sparse manner without affecting the quality of the regression. Note also that φ(t) does not depend on actual outputs y_{t-τ}, but rather only on computed x_{t-τ} and/or ŷ_{t-τ}. To construct φ(t1), φ(t2), . . . φ(tn) for well separated times t1, t2 . . . tn, we at most need to sample yₜ₁, yₜ₂, yₜₙ. Therefore although recording a vector φ(t) may involve successive samples of the computed quantities, the measured output yₜ is not required at successive time samples. Therefore, in some embodiments, the output of the non-linear element is downsampled (e.g., regularly downsampled at a fixed downsampling factor, or optionally irregularly), and corresponding vectors φ(t) at those times are also recorded, thereby enabling estimation based on the paired recorded data. In some examples, rather than recording φ(t) corresponding to the samples of the output yₜ, the delayed values x_{t-τ} and/or ŷ_{t-τ} are recorded. However, because of the form of the model, these quantities are required for successive time values. In some examples, some degree of subsampling is used for the input and model outputs, and interpolation is used to compute approximations of the terms needed for estimation of the parameters.

In a case where φ(t) does include ‘bursts’ of sampled yₜ at successive times, in order to construct φ(t), we would like to use several closely spaced y. One approach is to add to sparse sampling is to use a sparse-sampling compatible model to reconstruct the missing values ŷₜ. This can be called “model-based interpolation”, since we are using a model of the PA, as well as related data x or w, to properly interpolate and reconstruct the missing values y. Once those y are reconstructed, we compute feature vectors φ and perform the desired regression.

Approaches described above can be implemented in software, in hardware, or a combination of software and hardware. Software can include instructions stored on a tangible computer readable medium for causing a processor to perform functions described above. The processor may be a digital signal processor, a general purpose processor, a numerical accelerator etc. Factor graph elements may be implemented in hardware, for instance in fixed implementations, or using a programmable “probability processing” hardware. The hardware can also include signal processing elements that have controllable elements, for example, using discrete-time analog signal processing elements.

It is to be understood that the foregoing description is intended to illustrate and not to limit the scope of the invention, which is defined by the scope of the appended claims. Other embodiments are within the scope of the following claims.

What is claimed is:

1. A method for linearizing a non-linear system element comprising:
acquiring data representing inputs and corresponding outputs of the non-linear system element;
applying a model parameter estimation procedure using the acquired data to determine model parameters of a model characterizing input-output characteristics of the non-linear element;
accepting an input signal representing a desired output signal of the non-linear element;
processing the input signal to form a modified input signal according to the determined model parameters, the processing including, for each of a series of successive samples of the input signal applying an iterative procedure to determining a sample of the modified input signal according to a predicted output of the model of the non-linear element; and
providing the modified input signal for application to the input of the non-linear element.

2. The method of claim 1 wherein the non-linear system element comprises a power amplifier.

3. The method of claim 1 wherein applying the model parameter estimation procedure comprises applying a sparse regression approach, including selecting a subset of available model parameters for characterizing input-output characteristics of the model.

4. The method of claim 1 wherein applying the iterative procedure comprises applying a numerical procedure to solve a polynomial equation.

5. The method of claim 1 wherein applying the iterative procedure comprises applying a belief propagation procedure.

6. The method of claim 1 wherein applying the iterative procedure to determining a sample of the modified input signal according to a predicted output of the model of the non-linear element comprises first determining a magnitude of the sample and then a phase of said sample.

7. The method of claim 1 wherein the model characterizing input-output characteristics of the non-linear element comprises a memory polynomial.

8. The method of claim 1 wherein the model characterizing input-output characteristics of the non-linear element comprises a Volterra series model.

9. The method of claim 1 wherein the model characterizing input-output characteristics of the non-linear element comprises a model that predicts an output of the non-linear element based data representing a set of past inputs and a set of past outputs of the element.

10. The method of claim 9 wherein the model characterizing input-output characteristics of the non-linear element comprises an Infinite Impulse Response (IIR) model.

11. The method of claim 1 wherein acquiring data representing inputs and corresponding outputs of the non-linear system element comprises acquiring non-consecutive outputs of the non-linear element, and wherein the model parameter estimation procedure does not require consecutive samples of the output.

12. A system for linearizing a non-linear element, the system comprising:
an estimator configure to accept data representing inputs and corresponding outputs of the non-linear system element and apply a model parameter estimation procedure to determine model parameters of a model characterizing input-output characteristics of the non-linear element; and
a predistorter including a input for accepting an input signal representing a desired output signal of the non-linear element, an input for accepting the model parameters from the estimator, and a processing element for forming a modified input signal from the input signal, the processing element being configured to perform functions including, for each of a series of successive samples of the input signal applying an iterative procedure to determining a sample of the modified input signal according to a predicted output of the model of the non-linear element, and an output for providing the modified input signal for application to the input of the non-linear element.

13. The system of claim 12 wherein the estimator is configured to apply a sparse regression approach that includes selecting a subset of available model parameters for characterizing input-output characteristics of the model.

14. The system of claim 12 wherein the processing element is configured to apply a numerical procedure to solve a polynomial equation.

15. The system of claim 12 wherein the processing element is configured to apply a belief propagation procedure.

16. The system of claim 12 wherein the processing element is configured to determining a sample of the modified input signal according to a predicted output of the model of the non-linear element by first determining a magnitude of the sample and then a phase of said sample.

17. The system of claim 12 wherein the model characterizing input-output characteristics of the non-linear element comprises a model that predicts an output of the non-linear element based data representing a set of past inputs and a set of past outputs of the element.

18. Software stored on a non-transitory comprising instructions for causing a data processor to perform functions including:
acquiring data representing inputs and corresponding outputs of the non-linear system element;
applying a model parameter estimation procedure using the acquired data to determine model parameters of a model characterizing input-output characteristics of the non-linear element;
accepting an input signal representing a desired output signal of the non-linear element;
processing the input signal to form a modified input signal according to the determined model parameters, the processing including, for each of a series of successive samples of the input signal applying an iterative procedure to determining a sample of the modified input signal according to a predicted output of the model of the non-linear element; and
providing the modified input signal for application to the input of the non-linear element.
